(19) United States
(12) Patent Application Publication
(10) Pub. No.: US 2014/0305738 A1
(43) Pub. Date: Oct. 16, 2014

(54) AERIAL SYSTEM, IN PARTICULAR TURNTABLE LADDER SYSTEM

(71) Applicant: Iveco Magirus AG, Ulm (DE)

(72) Inventors: Christoph Lauterjung, Ulm (DE); Rene Peper, Neu-Ulm (DE)

(73) Assignee: Iveco Magirus AG, Ulm (DE)

(21) Appl. No.: 14/247,990

(22) Filed: Apr. 8, 2014

(30) Foreign Application Priority Data
Apr. 10, 2013 (EP) 13163117.8

(51) Int. Cl. E06C 5/32; E06C 5/04

(52) U.S. Cl. CPC E06C 5/32; E06C 5/04
USPC 182/19; 182/66.1

(57) ABSTRACT

The present invention refers to a turntable ladder system (18), comprising a turntable ladder (20) mounted on top of a rescue vehicle (10) and comprising an arm (24) that can be bent downwardly to the ground (28) in front of the driver's cabin (12) of the vehicle (10), and an operator stand (32, 40) located at the ladder (20) for operating the ladder (20), said operator stand (32, 40) comprising control means (34, 42) for controlling a movement of the arm (24). This turntable ladder system is characterized by manually operable confirmation means (36) located at the front of or laterally at the driver's cabin (12), said confirmation means (36) being operatively connected to the control means (34, 42) such that the bending movement of the arm (24) can be controlled by the control means (34, 42) only in case the confirmation means (36) are operated.

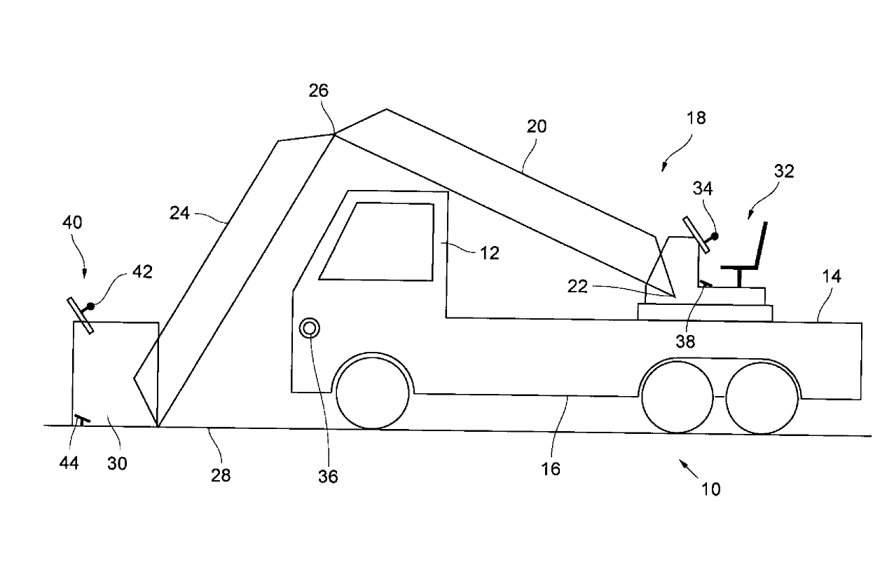

### CROSS REFERENCE TO RELATED APPLICATIONS

The present application claims priority to European Patent Application No. 13163117.8 filed Apr. 10, 2013.

### STATEMENT RE: FEDERALLY SPONSORED RESEARCH/DEVELOPMENT

Not Applicable.

### BACKGROUND OF THE INVENTION

1. Field of the Invention

The present invention refers to an aerial system, in particular a turntable ladder system, according to the preamble of claim 1.

2. State of the Art

Turntable ladder systems are mounted on top of rescue vehicles, especially fire fighting vehicles. They represent one embodiment of an aerial system that is equipped with a telescopic ladder, and although the following description may refer to aspects of turntable ladders, the present invention is applicable to other aerial systems comprising extractable ladders or telescopic arms that can be extracted to reach remote points in great height. To further improve the flexibility of such ladders, they comprise an articulated arm at their end that can be bent downwardly. By this construction it is possible to move the end of the ladder down to the ground to facilitate the access to the ladder, in particular to a cage that may be mounted to the ladder end. This means that an access to the ladder is possible not only from the deck of the rescue vehicle but also from the ground in the environment of the vehicle.

It is desired to lower the end of the arm in any position of the ladder, also including bending down the arm to the ground in front of the driver's cabin, which will be designated as “bending movement” in the following for the sake of simplicity. Usually the movement of the ladder is operated from a main operator stand that is located at the ladder near its turning axis on top of the vehicle. In this case there is the problem that the driver's cabin blocks the view of the ladder operator so that it is impossible to monitor the ground area in front of the vehicle where the end of the arm shall be positioned during and after the aforesaid bending movement. For this reason there have been severe administrative restrictions concerning the safety of the operation of such ladders, forbidding movements of ladder parts in areas that cannot directly be monitored from the main operator stand. It must be avoided under all circumstances that any persons present in the area in front of the driver's cabin could be hurt by a collision with the arm, or that the arm could collide with any other object in this area.

A similar problem arises when the bending movement of the ladder is operated from an auxiliary operator stand that can be located in a cage at the end of the ladder. The operator of this auxiliary operator stand may not be able to monitor the ground area completely, and there might be obstacles or persons beneath the cage or at his back that can collide with the cage.

### SUMMARY OF THE INVENTION

It is therefore an object of the present invention to provide an aerial system of the above kind that allows a safe lowering operation of the articulated arm to be bent downwardly to the ground in front of the driver's cabin of the vehicle, without the danger of any collision with persons or objects that are potentially present in this area. A general object is to improve the security of operation of such aerial systems.

This object is achieved by an aerial system comprising the features of claim 1.

The aerial system according to the present invention comprises a confirmation means that is located at the front of or laterally at the driver's cabin. This confirmation means is manually operable by a person monitoring the area in front of the driver's cabin. The confirmation means is operatively connected to the control means of the operator stand such that the above described bending movement of the arm can be controlled by these control means only in case the confirmation means are operated.

In this system a control of the ladder to bend the arm downwardly to the ground in front of the driver's cabin is possible from the operator stand only if the confirmation means are operated by an auxiliary person. Without this confirmation, it is impossible to initiate this bending movement. However, with the confirmation means being operated, the ladder operator can be sure that the ground before the driver's cabin is monitored and clear, i.e. free from any persons or objects, and he can be sure that there is no collision danger because this area is monitored by the auxiliary person.

Such an aerial system extends the operation range of the ladder even into areas that cannot be monitored by the operator at the operator stand. This operator stand can be represented by a main operator stand located at the ladder, or by an auxiliary operator stand that can be located in a cage at the end of the ladder, or by any other operator stand located elsewhere.

According to preferred embodiment of the present invention, the confirmation means comprise a push button. This button must be pushed to activate the control means at the ladder.

According to another embodiment, the confirmation means comprise a dead man button. Such a button must be held in its pushed state to be operated, and consequently the control means are activated only as long as the dead man button is held in this pushed state.

According to another preferred embodiment of the present invention, the control means comprise a start button to initiate an automatic move sequence previously stored in a storage means comprised within the control means to be automatically performed by the ladder, wherein the function of the start button is blocked when the confirmation means are not operated, and released when the confirmation means are operated. Such a start button to initiate an automatic move sequence facilitates the ladder operation, which can be automatized to some extend. However, this automatic move sequence can be activated only if the confirmation means are operated.

Preferably the operator stand is represented by a main operator stand located at the ladder, and the control means are represented by main control means of the main operator stand.

More preferably the main operator stand comprises activation means, in particular an activation button or an activation pedal, to be operated for releasing the main control means to control the bending movement of the arm. This activation means represents an additional security feature located at the main operator stand. As long as the ladder operator operates the activation means, i.e. pushes the activation button or presses the activation pedal with his foot, the main control means for the ladder can be operated to perform the bending movement. A respective move sequence of the ladder can be aborted immediately when the activation means is released.

According to another preferred embodiment, the activation means comprise a dead man button or a dead man pedal, which must be held in a pressed or pushed state all the time for releasing the main control means.

According to another preferred embodiment of the present invention, the turntable ladder system comprises an auxiliary operator stand located at the end of the arm for operating the ladder, said auxiliary operator stand comprising auxiliary control means for controlling a movement of the arm. Such an auxiliary operator stand can be arranged, for example, within a cage that is mounted at the end of the arm. A person standing in this cage can take over the control of the ladder by inputting operation commands into the auxiliary operator stand.

According to another preferred embodiment, the confirmation means are operatively connected to the auxiliary control means such that the bending movement of the arm can be controlled by the auxiliary control means only in case the confirmation means are operated.

According to an alternative embodiment, the auxiliary control means are operatively disconnected from the main control means such that the auxiliary control means can be operated independent from the operation state of the confirmation means. This function make sense because a person in the cage who is able to operate the auxiliary control means has a sufficient overview over the area into which the end of the arm is moved, and a confirmation means for the auxiliary control means is not necessary for this reason.

More preferably, the auxiliary operator stand comprises activation means, in particular an activation button or an activation pedal, to be operated for activating the auxiliary control means.

The present invention also refers to a method for operating an aerial system of the above kind, characterized by the step of operating the confirmation means at the front of or laterally at the driver's cabin manually for releasing the control means for controlling the bending movement of the arm in which the arm is bent downwardly to the ground in front of the driver's cabin of the vehicle, and a step of operating the control means for controlling the aforesaid bending movement of the arm.

More preferably, this method comprises the step of operating the activation means at the main operator stand to release the control means to control the bending movement of the arm.

### BRIEF DESCRIPTION OF THE DRAWINGS

These and other aspects of the invention will be apparent from and elucidated with reference to the embodiment described hereinafter.

The only FIGURE is a schematic view of a fire fighting vehicle comprising an embodiment of the aerial system according to the present invention.

### DETAILED DESCRIPTION OF THE INVENTION

In the FIGURE a fire fighting vehicle 10 is shown in a side view, with the driver's cabin 12 on the left side of the FIGURE. In the following the terms “front” and “rear” refer to the driving direction of the vehicle, i.e. the driver's cabin 12 is located at the front side. Behind the driver's cabin 12, a deck portion 14 is located on top of the rear part 16 of the vehicle. The deck portion 14 carries an aerial system, namely a turntable ladder system 18 comprising a turntable ladder 20. It is noted that the present invention can also be applicated to other aerial systems with a telescopic ladder with a plurality of segments.

The turntable ladder 20 is turnable around a vertical axis and can be articulated as a whole around a horizontal axis 22 near its vertical turning axis. The ladder 20 comprises a number of ladder segments that can be telescopically extracted to extend the length of the ladder. As a final ladder segment, an arm 24 is provided that can be bent around another horizontal axis 26 downwardly with respect to the ladder segment to which it is articulated. In the position shown in the FIGURE, the turnable ladder 20 is turned into a position in which it extends over the roof of the driver's cabin 12 so that the articulated arm 24 can be bent downwardly in its extracted position to the ground 28 in front of the driver's cabin 12. At the end of the arm 24, a cage 30 is mounted that can be entered from the ground 28 in the lowered position of the arm 24.

For operating the turnable ladder 20 a main operator stand 32 is located at the ladder 20. This main operator stand 32 comprises main control means 34 for controlling a movement of the ladder 20, i.e. the turning of the ladder 20 around its vertical axis, its extraction, the articulation angle of the ladder 20 and in particular a benting movement of the arm 24, and other functions. This main operator stand 32 may comprise, for example, a display showing different functions, and the main control means 34 may comprise a joystick, for example.

An operator at the main operator stand 32 can control the ladder 20 such that the arm 24 can be bent downwardly in the position of the FIGURE so that the cage 30 at the end of the arm 24 is lowered down to the ground 28 in front of the driver's cabin 12. However, this bending movement cannot be monitored visually by the operator at the main operator stand 32, because the driver's cabin 12 blocks the view from the main operator stand 32 to the ground 28 in front of the driver's cabin 12, and it is not possible to monitor this movement to avoid collisions with objects or persons located on this ground area.

To enable a secure operation of the turntable ladder system 18 in this situation, i.e. a secure bending movement to lower the arm 24 in front of the driver's cabin 12, a confirmation means 36 is located at the front portion of the driver's cabin 12. In the present embodiment the confirmation means 36 comprises a dead man button that can be pressed manually and must be held with a pressing force so as not to return into its released position. The confirmation means 36 is operatively connected to the main control means 34 such that bending movement can be controlled only if the confirmation means 36 is operated, i.e. the dead man button is held in its pressing position. As long as the dead man button is held pressing, an input via the main control means 34 to initiate and to control the bending movement of the ladder 20 is possible. If the dead man button is released and not pressing, an input of a control command into the main control means 34 for performing the bending movement is not possible, or at least the transfer of such commands towards said driving means of the ladder 20 is blocked. It is noted that performing other operations than performing the bending movement to lower the arm 24 in front of the driver's cabin 12 may be independent from the operation state of the confirmation means 36, so that it might still be possible to control the ladder's movement otherwise without the confirmation means 36 being operated.

In the situation described above, when it is intended to lower the arm 24 downwardly towards the ground area 28, a monitoring auxiliary person is necessary who stands in front or next to the driver's cabin 12 to monitor the ground area 28. If the ground area 28 is clear, she/he confirms the absence of any collision danger by pressing the dead man button 36. This pressing operation can be confirmed by an acoustic or visual signal to the auxiliary person. At the same time, the operator at the main operator stand 32 also gets a confirmation signal to confirm that the main control means 34 are activated so that input commands to perform the bending movement can be input at the main operator stand 32 and transferred to the ladder 20. In this situation the operator can operate the ladder 20 to bend the arm 24 downwardly towards the ground 28 even if he cannot monitor this area, because this monitoring activity is taken over by the auxiliary person. In any case a danger arises during this articulating movement, the auxiliary person may release the dead man button 36 to deactivate the main control means 34 and to abort the movement.

Any partial movement of the ladder 20 must not necessarily be controlled by means of the main control means 34 continuously. There is also the option that an automatic move sequence of the ladder 20 for performing the aforesaid bending movement is previously stored in a suitable storage means within the main control means 34, and this automatic move sequence is initiated by pressing a start button comprised within the main control means 34. After pressing the start button, the bending movement of the ladder 20 is performed automatically. The function of this start button is also blocked when the confirmation means 36 is not operated, and released when the confirmation means 36 is operated. In case the dead man button of the confirmation means 36 is released during the automatic move sequence, this move sequence is automatically stopped and aborted.

As another security feature, the main operator stand 32 comprises an activation means in form of an activation pedal 38. This activation pedal 38 must be held pressed for releasing the main control means 34 so that the bending movement to lower the arm 24 in front of the driver's cabin 12 can be performed. It can also be provided as a dead man pedal. If the activation pedal 38 is operated, an input of bending movement commands via the main control means 34 is possible. In an emergency situation the operator at the main operator stand 32 may release the activation pedal 38 immediately to stop the bending movement of the ladder 20 to prevent an accident. In the present embodiment comprising the confirmation means 36 at the driver's cabin 12 and the activation pedal 38 at the main operator stand 32, there are two independent security features to confirm an input of control commands via the main control means 32 concerning the bending movement. Both the confirmation means 36 and the activation pedal 38 must be operated to activate the main control means 34. Optionally the activation means that the main operator stand 34 may also comprise a dead man button.

Within the cage 30, an auxiliary operator stand 40 is located that comprises auxiliary control means 42 for controlling a movement of the arm. By means of this auxiliary operator stand 40, a person located within the cage 30 can control the arm 24 and its articulating movement to be lowered to the ground 28. These auxiliary control means 42 can be operatively disconnected from the main control means 34 such that the auxiliary control means 42 can be operated independent from the operation state of the confirmation means 36. This means that if the ladder 20 is operated from the cage 30 by means of the auxiliary control means 42, no confirmation via the confirmation means 36 is necessary, because a person located within the cage 30 can monitor the ground 28 himself, without the need of any auxiliary person to confirm this movement. Alternatively the confirmation means 36 can be operatively connected to the auxiliary control means 42 such that the bending movement of the arm 24 can be controlled by the auxiliary control means 42 only in case the confirmation means 36 are operated.

The auxiliary operator stand 40 within the cage 30 may also comprise other activation means, in particular an activation button or an activation pedal 44, that must be held pressed or pushed for activating the auxiliary control means 42. If this activation pedal 44 is released, an input of movement commands via the auxiliary control means 42 can be blocked to abort a moving sequence immediately.

What is claimed is:

1. Aerial system, in particular a turntable ladder system,
comprising a telescopic ladder mounted on top of a rescue vehicle and comprising an arm that can perform a bending movement in which the arm is bent downwardly to the ground in front of the driver's cabin of the vehicle,
and at least one operator stand for operating the ladder,
said operator stand comprising control means for controlling the bending movement of the arm,
characterized by manually operable confirmation means located at the front of or laterally at the driver's cabin,
said confirmation means being operatively connected to the control means such that the bending movement of the arm can be controlled by the control means only in case the confirmation means are operated.

2. Aerial system according to claim 1, wherein the confirmation means comprise a push button.

3. Aerial system according to claim 2, wherein the confirmation means comprise a deadman button.

4. Aerial system according to claim 1, wherein the control means comprise a start button to initiate an automatic move sequence previously stored in a storage means comprised within the main control means to be automatically performed by the ladder,
wherein the function of the start button is blocked when the confirmation means are not operated, and released when the confirmation means are operated.

5. Aerial system according to claim 1, wherein said operator stand is represented by a main operator stand located at the ladder, and said control means are represented by main control means of the main operator stand.

6. Aerial system according to claim 5, wherein the main operator stand comprises activation means, in particular an activation button or an activation pedal, to be operated for releasing the main control means to control the bending movement of the arm.

7. Aerial system according to claim 6, wherein the activation means comprise a deadman button or deadman pedal.

8. Aerial system according to claim 5, wherein by an auxiliary operator stand located at the end of the arm for operating the ladder, said auxiliary operator stand comprising auxiliary control means for controlling a movement of the arm.

9. Aerial system according to claim 8, wherein in that the confirmation means are operatively connected to the auxiliary control means such that the bending movement of the arm can be controlled by the auxiliary control means only in case the confirmation means are operated.

10. Aerial system according to claim 8, wherein the auxiliary control means are operatively disconnected from the main control means such that the auxiliary control means can be operated independent from the operation state of the confirmation means.

11. Aerial system according to claim 8, wherein the auxiliary operator stand comprises activation means, in particular an activation button or an activation pedal, to be operated for activating the auxiliary control means.

12. A method for operating an aerial system, the method comprising the steps of:
manually operating confirmation means at a front of or laterally at a driver's cabin of a vehicle for releasing a control means and for controlling a bending movement of an arm in which the arm is bent downwardly to a ground in front of the driver's cabin of the vehicle, and
operating the control means for controlling the aforesaid bending movement of the arm.

13. The method according to claim 12, wherein by the step of operating activation means at the operator stand to release the control means to control the bending movement of the arm.
